(19) United States
(12) Patent Application Publication
(10) Pub. No.: US 2003/0212633 A1
(43) Pub. Date: Nov. 13, 2003

(54) Bill collection system, method for collecting bills and recording medium wherein a program for making a computer execute the method for collecting bills is recorded

(75) Inventor: Tohru Senda, Kanagawa (JP)

Correspondence Address: GREENBLUM & BERNSTEIN, P.L.C., 1950 ROLAND CLARKE PLACE, RESTON, VA, 20191, US

(73) Assignees: Tohru Senda, Kanagawa (JP); Akio Niwa, Kanagawa (JP)

(21) Appl. No.: 10/428,767

(22) Filed: May 5, 2003

(30) Foreign Application Priority Data
May 9, 2002 (JP) 2002-134164

(51) Int. Cl. G06F 17/60

(52) U.S. Cl. 705/40

(57) ABSTRACT

It is an object of the present invention to provide a bill collection system and a method for collecting bills capable of improving the efficiency of collecting bills. A bill collection system comprising a bill collection server 3 connected to a network 1 to transmit a first payment request requesting for remittance of a remittance sum and a second payment request requesting for remittance of a prize sum, the bill collection server 3 comprising: a remittance source information receiving means; a storage means for storing the remittance source information; a prize drawing means for judging whether a remittance source wins a prize at the time of receiving a request for participation in prize drawing; and a prize sum determination means for determining a prize sum to be remitted to the remittance source when the remittance source wins the prize.

### DETAILED DESCRIPTION OF THE INVENTION

1. Field of the Invention

The present invention relates to a bill collection system, a method for bill collection, a recording medium wherein a program for making a computer execute the method for collecting bills is stored. More specifically, the present invention relates to a bill collection system, a method for bill collection, and the recording medium storing the bill collection system used appropriately by an organization constituted by a plurality of members to collect membership fees from the members or an individual or by a group to collect contributions from the unspecified number of people, the method for collecting bills and the program for making a computer execute the method for collecting bills.

2. Prior Art

An organization constituted by a plurality of members such as an alumni association, a block club, an aged people's club or an academic society has hitherto been collecting membership fees from the members thereof. A general method for payment is that each member hands the membership fee directly to the organization when the member participates in an event held by the organization, or goes to a banking facility or the like to transfer the membership fees to the organization's bank account.

Also, a contribution to a non-profitable organization such as a volunteer group has hitherto been paid by an individual or a group willing to pay the contribution by handing the contribution directly to the non-profitable organization collecting contributions on a street or transfer the contribution to the non-profitable organization's bank account from a banking facility.

3. Problem to be Solved by the Invention

In many cases however, the membership fees for the above-described organization or the contributions for the above-described non-profitable organization are not obliged to be paid to the remittance source which transfers the membership fees or the contributions. Accordingly, many remitters do not have a strong desire or have no desire for payment and it is therefore difficult to collect bills effectively.

The present invention was made to solve the above problem and an object thereof is to provide a bill collection system and a method for collecting bills capable of improving the efficiency of collecting bills.

Another object of the present invention is to provide a recording medium wherein a program for making a computer execute the above-described method for collecting bills is stored.

4. Means to Solve Problem

In order to attain the above-described objective, the bill collection system according to the present invention comprising a bill collection server collects bills via a network, the bill collection server comprising:

a remittance source information receiving means connected to the network to receive remittance source information including at least a remittance source name, a remittance destination name, a remittance sum, a remittance request and whether or not there is a request for participation in prize drawing;

a storage means for storing the remittance source information;

a prize drawing means for judging whether or not the remittance source wins a prize when receiving the request for participation in prize drawing; and

a prize sum determination means for determining a prize sum to be remitted to the remittance source when the remittance source wins the prize.

The bill collection server transmits a first payment request requesting for remitting the remittance sum and a second payment request requesting for remitting the remittance sum.

When using the bill collection system according to the present invention for remittance, a remitter (a remittance source) enters remittance source information including at least a remittance source name, a remittance destination name, a remittance sum, a remittance request and whether or not there is a request for participation in prize drawing by using an input device or the like. The entered remittance source information is received by the remittance source information receiving means provided with the bill collection server connected to the network and then stored to the storage means provided with the bill collection server.

Thereafter, the first payment request requesting for remittance of the remittance sum is transmitted from the bill collection server and the remittance sum is remitted to the remittance destination, thereby completing remittance of the remittance sum.

In the bill collection system according to the present invention, when the bill collection server receives the request for participation in prize drawing, the prize drawing means provided with the bill collection server judges whether or not the remittance source wins a prize.

Thereafter, when the remittance source wins the prize, the prize sum determination means provided with the bill collection server determines a prize sum to be remitted to the remittance source. The second payment request requesting for remittance of the prize sum is transmitted from the bill collection server and the prize sum determined by the prize sum determination means is then remitted to the remittance source.

As described above, the bill collection system according to the present invention remits from the remittance source to the remittance destination while the prize to be paid when the remittance source wins the prize is drawn at the time of receiving the request for participation in prize drawing by the remittance source information receiving means. Accordingly, the remittance source can enjoy drawing of the prize to be paid in case where the remittance source wins the prize at the time of remittance to the remittance destination. Consequently, the remittance source's desire to remit can be improved effectively, thereby improving the efficiency of collecting bills for the remittance destination.

The bill collection system according to the present invention collects bills via a network. Accordingly, the remitter (remittance source) enters the remittance source information to be received at the bill collection server connected to the network by using an input device or the like resulting in promotion of the use of a network such as an internet and electronic equipment equipped with an input device.

The bill collection system according to the present invention reduces an amount of work required for remittance and makes it easier to remit in comparison to the conventional method for remittance which the remitter goes to a banking facility or the like for remittance by transfer to a remittance destination's bank account. Accordingly, the remittance source who is, for example, reluctant to remit because of difficulty in going to the banking facility or the like, can be improved in the desire to remit resulting in effective improvement of the bill collection efficiency for the remittance destination.

The bill collection server in the above-described bill collection system is generated from:

the list of participants in prize drawing wherein only the remittance source information including the information instructing the request for participation in prize drawing extracted from the stored remittance source information is registered; and

the list of participants in prize drawing, the bill collection server being also capable of containing the list of receptions before a preset time containing receptions of the remittance source information before a preset time.

In the such like bill collection system, the bill collection server contains the list of participants in prize drawing and the list of receptions before a preset time. Accordingly, the list of participants in prize drawing and the list of receptions before a preset time can be searched effectively from the stored remittance source information.

Further, in the above-described bill collection system, the remittance source information includes the prediction information predicting fluctuated financial information determined having a value determined at a preset time in each predetermined period is disclosed, the bill collection server obtains an information receiving time whereat the preset time and the remittance source information are received, and the prize drawing means judges whether or not the remittance source wins the prize from the value of the fluctuated financial information related to the preset time by using the list of receptions before a preset time.

In the suchlike bill collection system, the value of the fluctuated financial information is disclosed at each predetermined period and the prize drawing means judges whether or not the remittance source wins the prize from the value of the fluctuated financial information. Accordingly, prize drawing can be carried out so that whether or not the remittance source wins the prize is determined justly and fairly and, at the same time, the remittance source can judge easily whether or not the remittance source himself/herself wins the prize. The remittance source judges whether or not the remittance source himself/herself wins the prize by collating the prediction information and the fluctuated financial information. Consequently, the remittance source sees the fluctuated financial information resulting in a growing interest in financial information and economic activities.

In the suchlike bill collection system, by containing the list of participants in prize drawing and the list of receptions before a preset time, the bill collection server enables the prize drawing means to judge whether or not the remittance source wins the prize from the value of the fluctuated financial information related to the preset time by using the list of receptions before a preset time. Accordingly, the prize drawing means can judge whether or not the remittance source wins the prize effectively.

Further, in the above-described bill collection system, the remittance source information receiving means may also be the one which generates the prediction information from the received remittance sum.

In the suchlike bill collection system, the prediction information is received at the remittance source information receiving means by a simple entry of the remittance sum made by the remitter. Accordingly, it is less troublesome for the remitter to enter the remittance source information resulting in realization of the bill collection system capable of easier remittance in comparison to case where the remitter needs to enter all information items included in the remittance source information one by one.

In the above-described bill collection system, the bill collection server may be the one which comprises the prediction information disclosure means for disclosing the prediction information stored in the bill collection server.

In the suchlike bill collection system, the prediction information stored in the bill collection server is disclosed. Accordingly, when, for example, the remitter enters the remittance source information, the remitter can refer to the prediction information stored in the bill collection server and then enter whether or not there is a request for participation in prize drawing and the prediction information when entering the remittance source information.

In the above-described bill collection system, the remittance source information receiving means may also be the one which receives information indicating whether or not to transmit the remittance source information to the remittance destination or not.

The suchlike bill collection system enables refusal of transmitting the remittance source information to the remittance destination when the remittance source information is not necessarily transmitted to the remittance destination, and this system can therefore prevent a trouble such as the malicious use of the remittance source information.

In the suchlike bill collecting system, the remittance source information can be transmitted to the remittance destination when there is a necessity of transmitting the remittance source information to the remittance destination. When the remittance source information is to be transmitted to the remittance destination, since this bill collection system is equipped with the bill collection server for receiving and storing the remittance source information, the remittance source information can be used without being entered and stored to a computer means at the remittance destination by using the computer means or the like, which is connectable to the network, of the remittance destination to receive and store the remittance source information via the network. Accordingly, the remittance source can judge easily, for example, whether money is remitted from the remittance source and the remittance sum while easily managing the information related to the remittance source.

In the above-described bill collection system, a payment means for paying at least a part of both or either of the remittance sum and/or the prize sum and a display device for displaying the contents of received information are connected to the network. The display device may also be the one which is capable of displaying information, provided by a fund provider who provides funds to the payment means, when displaying the contents of the received information.

The suchlike bill collection system is usable by the fund provider for publicity campaign together with being capable of reducing a financial burden of the remittance source.

The above-described bill collection system may also be the one used by an organization constituted by a plurality of members for collecting membership fees from the members.

In the above-described bill collection system, the remittance sum may also be a contribution sum.

In order to attain the above objective, the bill collection system according to the present invention collects bills via the network, the bill collection system comprising the steps of:

the remittance source information receiving means provided with the bill collection server connected via the network receiving the remittance source information including at least the remittance source name, the remittance destination name, the remittance sum, the remittance request and whether or not there is a request for participation in prize drawing;

the storage means provided with the bill collection server storing the remittance information;

when the bill collection server receives the request for participation in prize drawing, the prize drawing means provided with the bill collection server judging whether or not the remittance source wins the prize;

when the remittance source wins the prize, the prize sum determination means provided with the bill collection server determining the prize sum to be remitted to the remittance source;

the bill collection server transmitting the first payment request requesting for remittance of the remittance sum; and

the bill collection server transmitting the second payment request requesting for remittance of the prize sum.

Further, to attain the above objective, a recording medium according to the present invention records a program readable by a computer for making a computer execute a method for collecting bills via the network, the program making the bill collection server connected via the network execute the steps of:

the remittance source information receiving means provided with the bill collection server receiving the remittance source information including at least the remittance source information, the remittance destination name, the remittance sum, the remittance request and whether or not there is a request for participation in prize drawing;

the storage means provided with the bill collection server storing the remittance information;

when the bill collection server receives the request for participation in prize drawing, the prize drawing means provided with the bill collection server judging whether or not the remittance source wins the prize;

when the remittance source wins the prize, the prize sum determination means provided with the bill collection server determining the prize sum to be remitted to the remittance source;

the bill collection server transmitting the first payment request requesting for remittance of the remittance sum; and

the bill collection server transmitting the second payment request requesting for remittance of the prize sum.

### BRIEF DESCRIPTION OF THE DRAWINGS

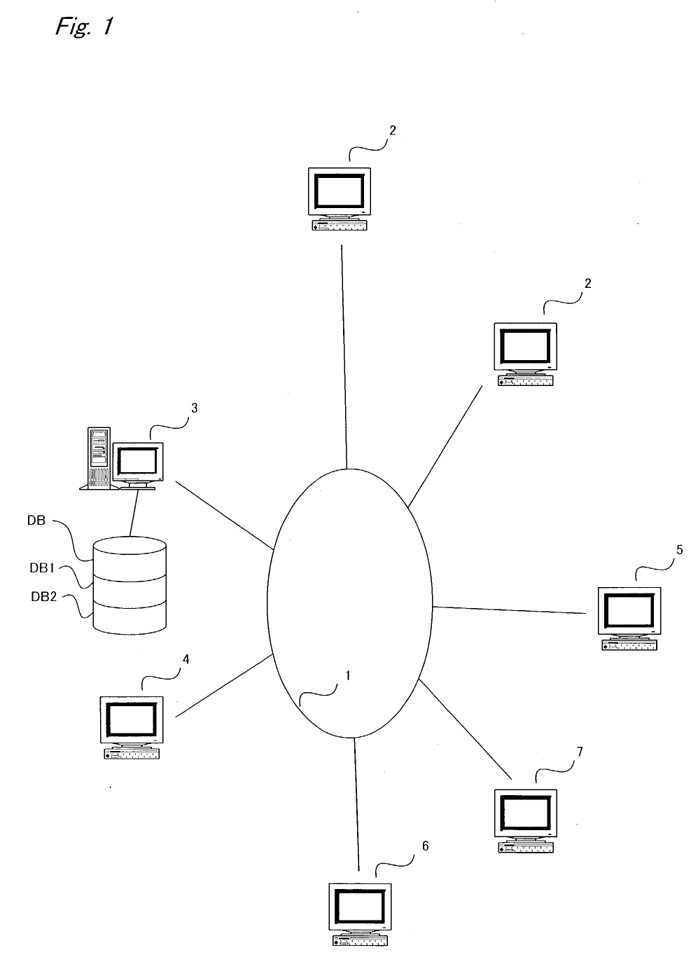

### FIG. 1

FIG. 1 shows a schematic view showing an example of a bill collection system according to the present invention.

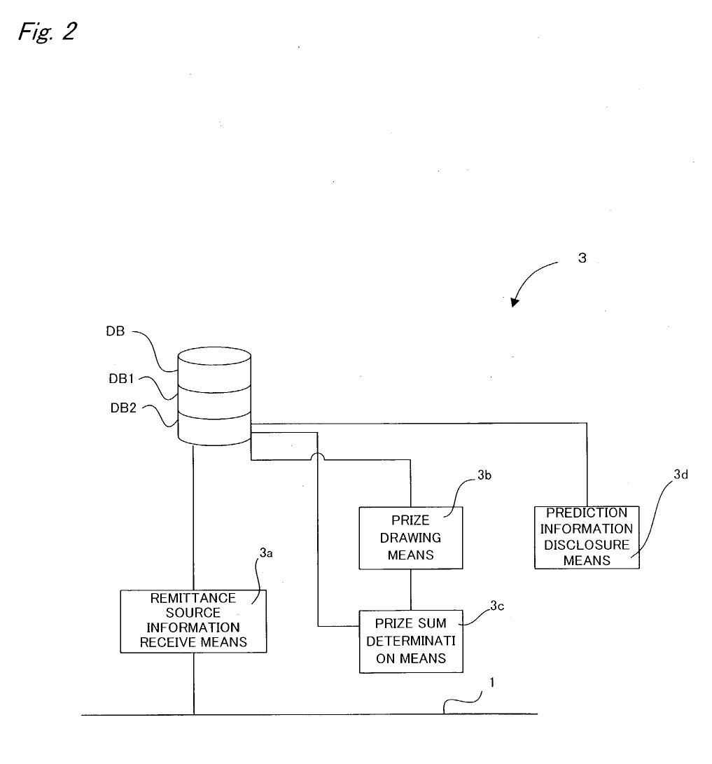

### FIG. 2

FIG. 2 shows a view for explanation of an example of a bill collection server.

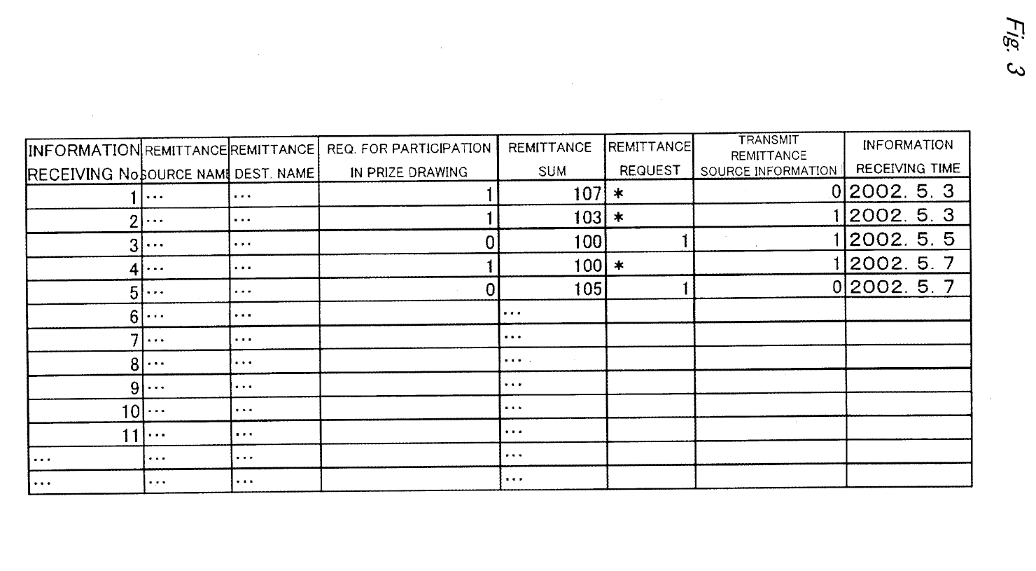

### FIG. 3

FIG. 3 shows a view showing an example of a data structure of information received by a bill collection server 3.

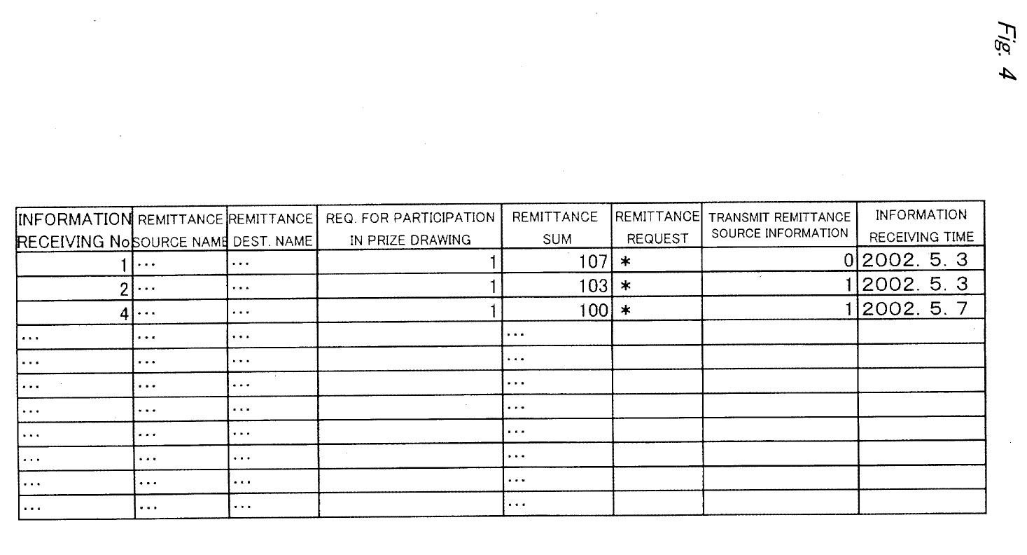

### FIG. 4

FIG. 4 shows a view showing an example of a list of participants in prize drawing.

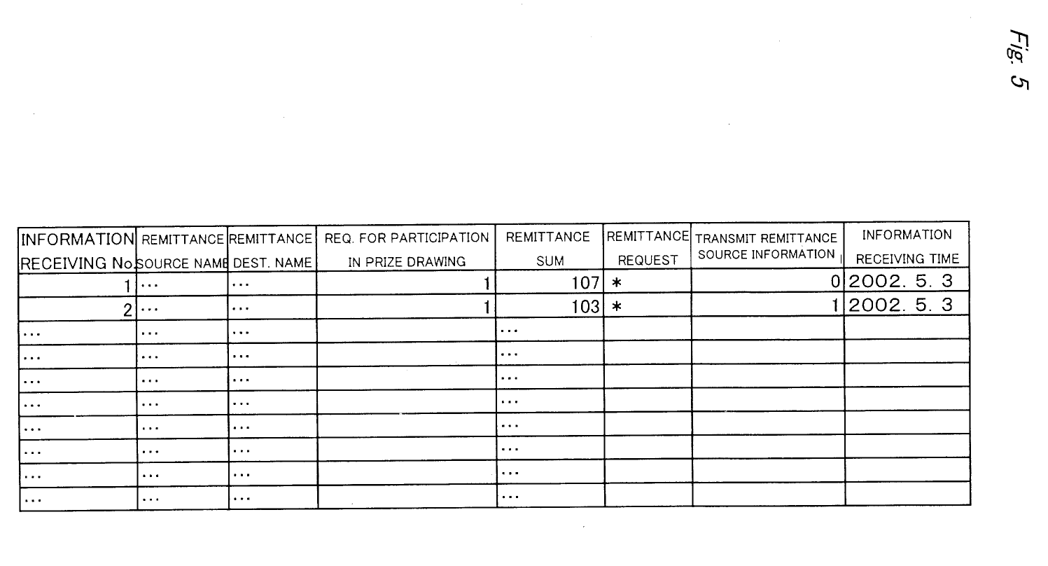

### FIG. 5

FIG. 5 shows a view showing an example of a list of receptions before a preset time.

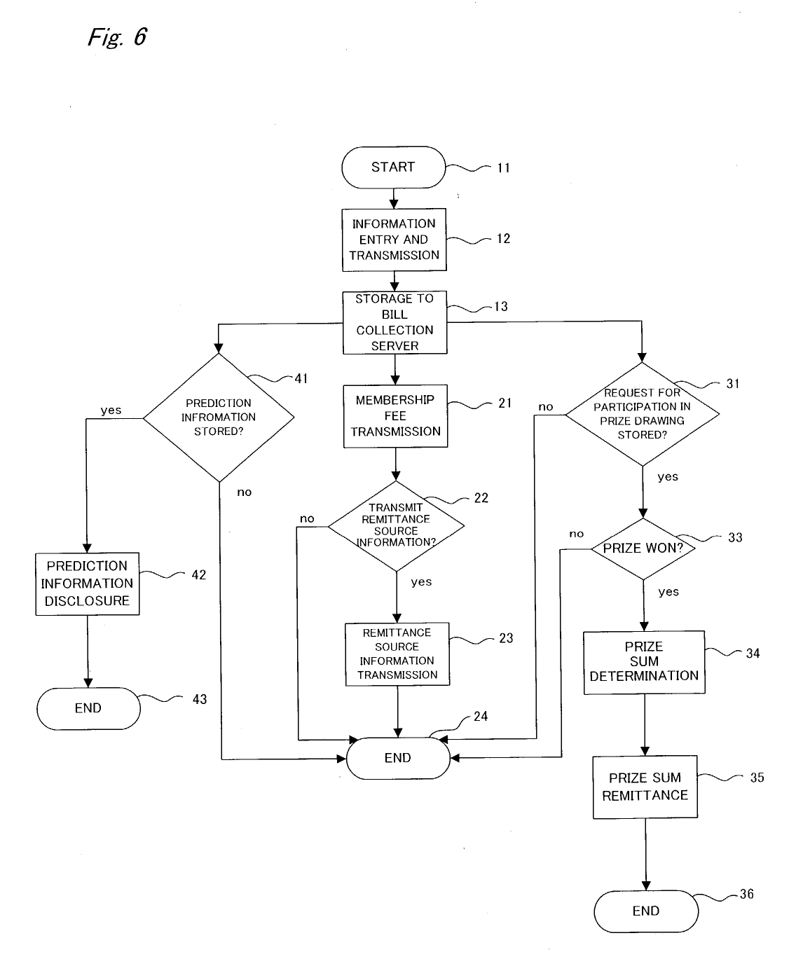

### FIG. 6

FIG. 6 shows a view showing a flowchart for explanation of the bill collection system according to the present embodiment.

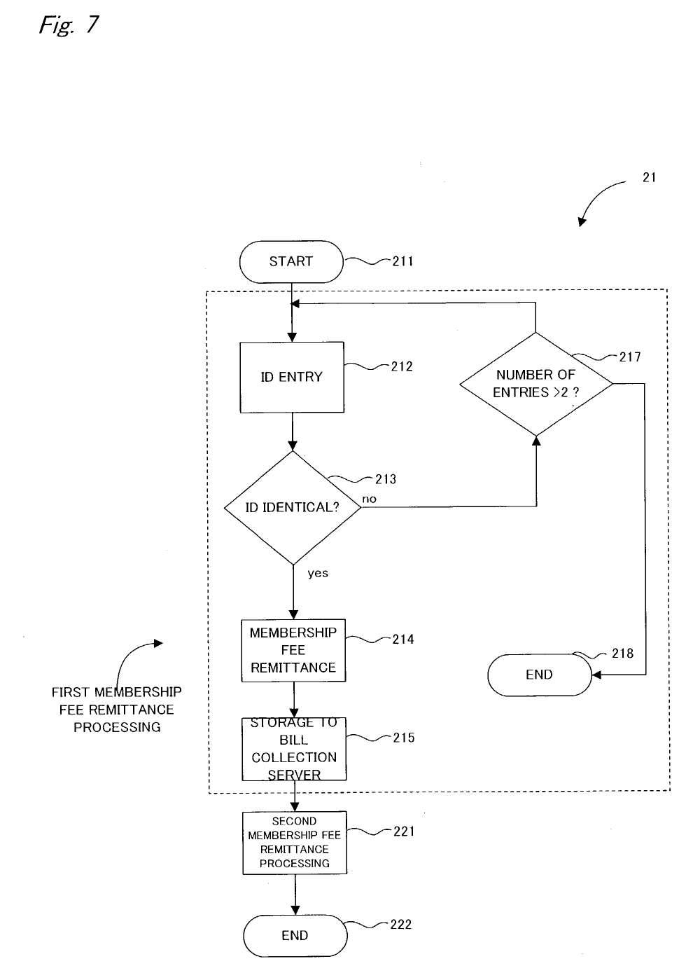

### FIG. 7

FIG. 7 shows a view showing a flowchart for explanation of step 21.

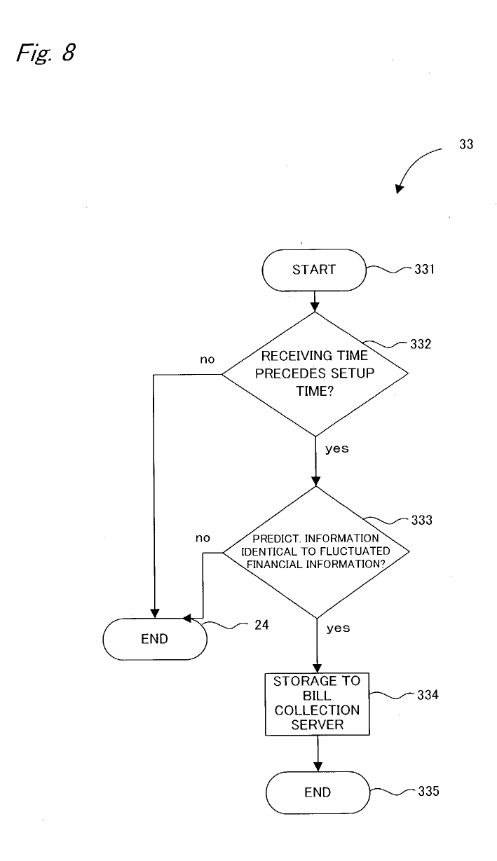

### FIG. 8

FIG. 8 shows a view showing a flowchart for explanation of step 33.

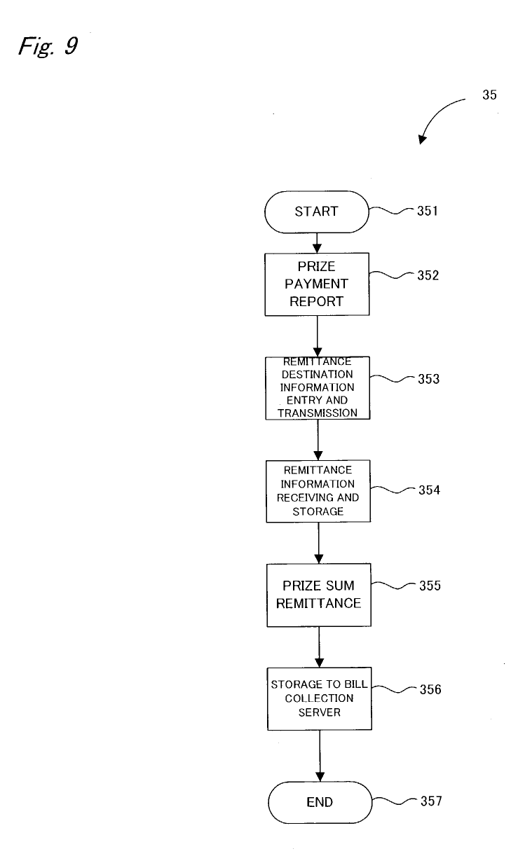

### FIG. 9

FIG. 9 shows a view showing a flowchart for explanation of step 35.

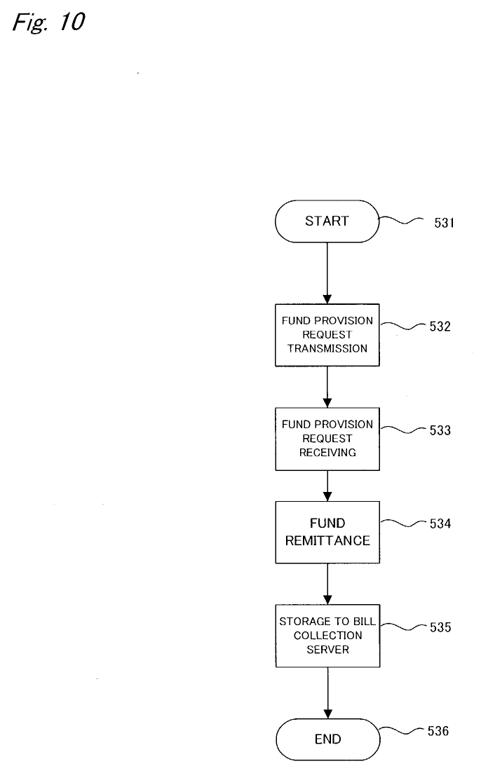

### FIG. 10

FIG. 10 shows a view showing a flowchart for explanation of payment of at least a part of both or either of a remittance sum and/or a prize sum by a third payment means.

### REFERENCE CHARACTERS

1: Network

2: Remittance source information transmission means

3: Bill collection server

4: First payment means

5: Second payment means

6: Third payment means

7: Computer means

### BEST MODE FOR CARRYING OUT THE INVENTION

Examples of applying the bill collection system, the method of collecting bills and the recording medium according to the present invention to the organization constituted by a plurality of members for collecting membership fees from the members will be described with reference to the drawings. However, the present invention is not limited to those examples.

FIG. 1 is a schematic diagram showing an example of the bill collection system according to the present invention. In FIG. 1, numeral 1 represents a network. The network 1 is connected with a plurality of remittance source information transmission means 2, a bill collection server 3, a first payment means 4, a second payment means 5, a third payment means 6 and a computer means 7.

An internet is an example of the network 1. Any other network however can be used so far as being capable of transmitting and receiving remotely remittance source information by communications using an appropriate protocol such as LAN/WAN. Examples of the communication protocol usable herein include, but not limited to TCP/IP.

The remittance source information receiving means 2 receives the remittance source information including a member name entered by a member (a remittance source) at the time of paying a membership fee, a name of an organization which is a remittance destination, a membership fee sum to be remitted, a remittance request requesting for remittance of the membership fee, whether or not there is a request for participation in prize drawing and prediction information predicting fluctuated financial information at a preset time, and information indicating whether or not to transmit the remittance source information to the organization. Thereafter, the remittance source information transmission 2 transmits the above-described remittance source information to the bill collection server 3 via the network 1.

The remittance source information transmission means 2 is equipped with a display device for displaying the remittance source information to be transmitted to the bill collection server 3 and an input device for the member to enter the remittance source information. This remittance source information transmission means 2 is installed in an arbitrary place to be used by the member to remit. The display device provided with the remittance source information transmission means 2 displays information provided by an enterprise, a group or an individual (a fund provider) providing funds to the third payment means 6 when displaying the remittance source information to be transmitted to the bill collection server 3.

Examples of the remittance source information receiving means 2 include, but not limited to a personal computer and a cellular phone. The remittance source information transmission means 2 may be the one shared by a plurality of members or used by one of the plurality of members alone.

The bill collection server 3 is installed by a bill collection dealer which receives contract for collection of membership fees from an organization with charge. The bill collection server 3 is for receiving and storing the remittance source information transmitted from the remittance source information transmission means 2 and the information indicating whether or not to transmit the remittance source information to the organization. This bill collection server 3 obtains a preset time and a time of receiving the remittance source information. The bill collection server 3 also generates a list of participants in prize drawing DB1 wherein only the remittance source information including the information instructing a request for participation in prize drawing from the remittance source information and the information indicating whether or not to transmit the remittance source information both registered in the bill collection server 3, and list of receptions of the remittance source information before a preset time DB2 from the list of participants in prize drawing DB1.

The bill collection server 3 transmits a first payment request requesting for remittance of the remittance sum to a first payment means 4 and a second payment request requesting for remittance of a prize sum to a second payment means 5.

As shown in FIG. 2, the bill collection server 3 is equipped with a remittance source information receiving means 3a, a database DB, a prize drawing means 3b, a prize sum determination means 3c and a prediction information disclosure means 3d.

The remittance source information receiving means 3a receives the remittance source information transmitted from the remittance source information transmission means 2 and the information indicating whether or not to transmit the remittance source information to the organization. The prediction information can be received by receiving a remittance sum while the request for participation in prize drawing can be received by receiving a remittance request.

The database DB is a storage means for storing the remittance source information and the information indicating whether or not to transmit the remittance source information to the organization and capable of extracting and providing only necessary information from the list of participants in prize drawing DB1 and the list of receptions before a preset time DB2 contained therein.

The prize drawing means 3b judges whether or not a member wins a prize when the bill collection server 3 receives the request for participation in prize drawing by judging whether or not the remittance source wins the prize from a value of fluctuated financial information related to a preset time by using the list of receptions before a preset time DB2.

The prize sum determination means 3c determines a prize sum to be remitted to the member when the member wins the prize.

The data structure of the information received by the bill collection server will be described with reference to an example. FIG. 3 is a view showing an example of the data structure of the information received by the bill collection server 3. As shown in FIG. 3, the information received by the bill collection server 3 is assigned with numbers in order of receiving by the bill collection server 3, arranged according to the information receiving numbers, and divided into items including items constituting the remittance source information, the information indicating whether or not to transmit the remittance source information to the organization, and information receiving times.

The database DB wherein the information received by the bill collection server 3 is stored contains the list of participants in prize drawing shown in FIG. 4 wherein only the remittance source information including the information indicating the request for participation in prize drawing extracted from the information stored in the database DB is registered, and the list of receptions of the remittance source information before a preset time DB2 generated from the list of participants in prize drawing shown in FIG. 4. FIG. 5 shows the list of receptions before a preset time DB2 generated from the list of participants in prize drawing DB1 shown in FIG. 4 as an example of the list of receptions before a preset time DB2 assuming that the set time is May 6, 2002.

Examples of the bill collection server 3 usable herein include a computer means or the like equipped with a recording means such as a hard disk, a magnetic disk, an optical disk, an opto-magnetic disk, a DVD, a magnetic tape, a floppy (registered trademark)disk or the like.

Examples of the computer means usable herein as the bill collection server 3 include a personal computer and a workstation. More specifically, a CPU such as PENTIUM (registered trademark) or another type of CPU having a compatibility with PENTIUM (registered trademark). Examples of the CPU usable herein include, but not limited to a personal computer and a workstation each capable of running an operating system therein such as WINDOWS (registered trademark), WINDOWS (registered trademark) NT, OS/2 (trade mark, manufactured by International Business Machines Corporation), AIX (trademark, manufactured by International Business Machines Corporation), UNIX and LINAX.

The first payment means 4 remits the membership fees from the members to the bill collection dealer. Examples of the first payment means 4 include, but not limited to a banking facility called “net bank” wherein the members have the accounts thereof and a means for settlement using credit cards signed up by the members.

The second payment means 5 remits the membership fees from the bill collection dealer to the organization while remitting the prizes from the bill collection dealer to the members. Examples of the second payment means 5 include, but not limited to the banking facility called “net bank” wherein the bill collection dealer equipped with the bill collection server 3 has the account thereof and the means for settlement using a credit card signed up by the bill collection dealer.

The third payment means 6 pays at least a part of both or either of the membership fees and/or the prizes. Examples of the third payment means 6 include, but not limited to the banking facility called “net bank” wherein the fund provider has the account thereof and the means for settlement using a credit card signed up by the fund provider.

The above banking facilities and the means for settlement using a credit card as examples of the first payment means 4, the second payment means 5 and the third payment means 6 may be the same or different or may include a common banking facility or a settlement means.

The computer means 7 is installed in an office of the organization in use for receiving and storing the remittance source information via the network 1. An example of the computer means 7 usable herein is the same equipment as the bill collection server 3.

FIG. 6 is a view showing a flowchart for explanation of the bill collection system according to the present embodiment. As shown in FIG. 6, in this bill collection system, the operation starts from step 11. In step 12, the member enters the member name, the name of the remittance destination organization, the membership fee sum to be remitted, the remittance request requesting for remittance of the membership fee, whether or not to request for participation in prize drawing, the remittance source information including the prediction information predicting the fluctuated financial information at a preset time, and the information indicating whether or not to transmit the remittance source information to the organization from the input device provided with the remittance source information transmission means 2.

In addition, in this bill collection system, when the remittance sum is entered, the prediction information is received at the remittance source information receiving means 3a, and when the remittance request is entered, the request for participation in prize drawing is received at the remittance source information receiving means 3a. Whether to request for participation in prize drawing need be entered only when it is not desired to participate in prize drawing.

The fluctuated financial information regarding this bill collection system means financial information including previously selected one or more item, and the value thereof is disclosed at each predetermined period. Specifically, the financial information usable herein includes one or more item previously selected from, for example, a stock market barometer such as TOPIX or a mean stock price, a stock price of a particular brand, particular future goods, and the like.

Further, in step 12, when the member enters the remittance source information and the information indicating whether or not to transmit the remittance source information to the organization, the contents of the entered information and the information provided from the fund provider are displayed on the display device provided with the remittance source information transmission means 2.

The remittance source information entered from the input device and the information indicating whether or not to transmit the remittance source information to the organization in step 12 are transmitted to the bill collection server 3 connected via the network. Thereafter, the remittance source information and the information indicating whether or not to transmit the remittance source information to the organization transmitted to the bill collection server 3 are received at the remittance information receiving means 3a provided with the bill collection server in step 13 and stored to the database DB.

In this bill collection system, the bill collection server 3 obtains the preset time and the time whereat the remittance source information is received and then generates the list of participants in prize drawing DB1 and the list of receptions before a preset time DB2 from the remittance source information stored in the database DB.

Subsequently, in this bill collection system, the first payment request requesting for remittance of the remittance sum is transmitted from the bill collection server 3 to the first payment means 4 connected via the network 1 and, in step 21, the remittance sum is transmitted to the organization.

FIG. 7 is a view showing a flowchart for explanation of step 21. As shown in FIG. 7, in step 21, the membership fee remitted from the member to the organization is remitted temporarily to the bill collection dealer (hereinafter called “first membership fee remittance processing”) and then remitted from the bill collection dealer to the organization (hereinafter called “second membership fee remittance processing”).

In step 21, the first membership fee remittance processing starts from step 211. In the first membership remittance processing, an ID, which has been agreed between the member and the first payment means 4, is first requested to be entered in step 212 to identify the member in the same manner as in the general bank transfer or the settlement using the credit card. In step 213, the ID, which has been agreed between the member and the first payment means 4, is collated to the ID received in step 212 to identify the member who has requested for remittance.

When the ID, which has been agreed between the member and the first payment means 4, does not match the ID received in step 212 (NO), the step transits to step 217. When the number of times the ID is received in step 212 is less than twice, the ID is requested to be received again in step 212. When this number of times exceeds twice, the procedure branches to 218 and ends.

When the ID, which has been assigned between the member and the first payment means 4, matches the ID received in step 212 (YES), the membership fee is remitted in step 214, the end of the first membership fee remittance processing is stored to the bill collection server 3 and the procedure goes to step 221 and the second membership fee remittance processing starts.

In the second membership fee remittance processing, the bill collection dealer is confirmed using the ID, which has been agreed between the bill collection dealer and the second payment means 5, to identify the bill collection dealer in the same manner as in the first membership fee remittance processing in steps 212 to 218. Thereafter, the membership fee is remitted, the end of the second membership fee remittance processing is stored to the bill collection server 3 and the procedure ends in step 222.

As shown in FIG. 6, in this bill collection system, when the remittance sum is remitted to the organization in step 21, whether or not to transmit the remittance source information to the organization is confirmed in step 22.

When the remittance source information is transmitted to the organization (YES), the remittance source information is transmitted from the bill collection server 3 to the computer means 7 via the network 1 in step 23, received and stored to the computer means 7, and the procedure ends in step 24. When the remittance source information is not transmitted to the organization (NO), the procedure goes to step 24 and ends.

As shown in FIG. 6, in this bill collection system, whether or not the request for participation in prize drawing is stored to the bill collection server 3 is judged in step 31.

When the request for participation in prize drawing is not stored to the bill collection server 3 (NO), the procedure goes to step 24 and ends. When the request for participation in prize drawing is stored to the bill collection server 3 (YES), the prize drawing means 3b provided with the bill collection server 3 judges whether or not the member wins the prize.

FIG. 8 is a view showing a flowchart for explanation of the step 33. As shown in FIG. 8, step 33 starts from step 331 and whether or not the information receiving time precedes the preset time is judged in step 332.

When the information receiving time does not precede the preset time (NO), the procedure goes to step 24 and ends. When the information receiving time precedes the preset time (YES), whether or not the value of the fluctuated financial information at the preset time is identical to the prediction information is judged in step 333.

When the value of the fluctuated financial information at the preset time is not identical to the prediction information (NO), the procedure goes to step 24 and ends. When the value of the fluctuated financial information at the preset time is identical to the prediction information (YES), the fact that the value of the fluctuated financial information at the preset time is identical to the prediction information, that is, the member wins the prize is stored to the bill collection server 3 in step 334 and the procedure ends in step 335.

As shown in FIG. 6, in this bill collection system, when the member wins the prize (YES), the prize sum to be remitted to the member is determined by the prize sum determination means 3c provided with the bill collection server 3 in step 34, the second payment request requesting for remittance of the prize sum is transmitted from the bill collection server 3 to the second payment means 5 connected via the network 1, and the prize sum determined by the prize sum determination means 3c is remitted to the member.

FIG. 9 is a view showing a flowchart for explanation of step 35. As shown in FIG. 9, step 35 starts from step 351 and a prize payment report reporting that the prize sum is paid to the member is transmitted from the second payment means 5 to the remittance source information transmission means 2 in step 352. When the prize payment report is received at the remittance source information transmission means 2, the member enters the remittance destination information indicating the remittance destination of the prize sum, such as a bank account, from the input device provided with the remittance source information transmission means 2 in step 353, and the remittance destination information is transmitted to the bill collection server 3, the remittance source information transmitted to the bill collection server 3 is received at the remittance source information receiving means 3a provided with the bill collection server 3 and stored to the database DB in step 354.

When the remittance source information is stored to the bill collection server 3, the prize is remitted in step 355. As step 355, the prize sum can be remitted after confirming the bill collection dealer to whom the prize sum is paid by using the ID to identify the organization, which has been agreed between the bill collection dealer and the second payment means 5, in the same manner as in the above-described second membership fee remittance processing. Thereafter, when the remittance of the prize ends, the end of the remittance of the prize is stored to the bill collection server 3 in step 356 and the procedure ends in step 357.

As shown in FIG. 6, in this bill collection system, whether the prediction information is stored to the bill collection server is judged in step 41. When the prediction information is stored to the bill collection server 3 (YES), the prediction information is disclosed according to a prediction information disclosure request from the prediction information disclosure means 3d by, for example, being displayed on the display device provided with the remittance source information transmission means 2, and then the procedure ends in step 43. When the prediction information is not stored to the bill collection server 3, the procedure goes to step 24 and ends.

In this bill collection system, at least a part of both or either of the remittance sum remitted in step 21 and/or the prize sum remitted in step 35 is paid from the third payment means 7.

FIG. 10 is a view showing a flowchart for explanation of payment of at least a part of both or either of the remittance sum and/or the prize sum by the third payment means.

As shown in FIG. 10, the payment by the third payment means starts from step 531 and a fund provision request requesting for a provided sum, which has been agreed between the fund provider and the bill collection dealer and which is equivalent to at least a part of both or either of the remittance sum and/or the prize sum, is transmitted from the bill collection server 3 to the third payment means 6 via the network 1. When the fund provision request is received at the third payment means 6 in step 533, the provided sum is remitted to the bill collection dealer. As step 534, the fund can be remitted after confirming the fund provision source paying the provided sum by using the ID to identify the fund provision source, which has been agreed between the fund provider and the third payment means 6, in the same manner as, for example, in the remittance of the membership fee in step 21 shown in FIG. 7. Thereafter, when the remittance of the fund ends, the end of the remittance of the fund is stored to the bill collection server 3 in step 535 and the procedure ends in step 536.

In addition, when at least a part of the remittance sum to be remitted in step 21 is paid from the third payment means 7, a return sum, which is at least a part of the remittance sum, is remitted, for example, as follows.

That is, in this bill collection system, when at least a part of the return sum is paid from the third payment means 7, the third payment request requesting for return of the return sum is transmitted from the bill collection server to the second payment means 5 connected via the network 1 in the same manner as in the remittance of the prize sum in step 35, and the return sum is remitted to the member.

More specifically, the return payment report reporting that the return sum is paid to the member is transmitted from the second payment means 5 and received at the remittance source information transmission means 2, and when the member enters the remittance destination information indicating the remittance destination of the return sum, such as a bank account, from the input device provided with the remittance source information transmission means 2, the remittance destination information is received at the remittance source information transmission means 2 and then transmitted to the bill collection server 3. Thereafter, the remittance source information transmitted to the bill collection server 3 is received and stored to the bill collection server 3.

In the bill collection system and the method for collecting bills according to the present embodiment, the remittance is carried out from the member to the organization while the prize to be paid to the member when the member wins the prize is drawn at the time the remittance source information receiving means 3a receives the request for participation in prize drawing. Accordingly, the member can enjoy drawing of the prize to be paid in the case where the member wins the prize at the time of remittance of the membership fee. Consequently, the member's desire to remit can be improved effectively thereby improving the efficiency of collecting bills for the organization.

The bill collection system is equipped with the remittance source information transmission means 2, the bill collection server 3, the first payment means 4 and the second payment means 5 connected to the network. Accordingly, the member can remit the membership fee to the organization by simple entry from the input device provided with the remittance source information transmission means 2 thereby reducing an amount of work required for remittance and making it easy to remit in comparison to the conventional general method for remittance by transfer to a destination's bank account from a banking facility or the like.

The value of the fluctuated financial information is determined and disclosed at each predetermined period and the prize drawing means 3b judges whether the member wins the prize from the value of the fluctuated financial information at the preset time. Accordingly, prize drawing can be carried out so that whether or not the member wins the prize is judged justly and fairly and, at the same time, the member can confirm easily whether or not the member himself/herself wins the prize.

In the bill collection system and the method for collecting bills according to the present embodiment, the prediction information is received at the remittance source information transmission means by a simple entry of the remittance sum made by the member. On the other hand, the request for participation in prize drawing is received at the remittance source information receiving means 3a by a simple entry of the remittance request made by the member. Accordingly, it is less troublesome for the member to enter the remittance source information resulting in easier remittance in comparison to the case wherein the member enters all information items included in the remittance source information one by one.

The bill collection server 3 is equipped with the prediction information disclosure means 3d for disclosing the prediction information stored in the bill collection server 3. Accordingly, the member can refer to the prediction information stored in the bill collection server 3 and enter whether there is a request for participation in prize drawing and the prediction information at the time of entering the remittance source information.

The remittance source information receiving means 3a receives the information indicating whether or not to transmit the remittance source information to the organization, and transmission of the remittance source information to the organization can therefore be refused when the remittance source information is not necessarily transmitted to the organization. A trouble such as a malicious use of the remittance source information can thus be prevented so as to realize the bill collection system having a high level of safety and a high reliability.

When the remittance source information is transmitted to the organization, the remittance source information can be used without entering and storing any information to the computer means 7 at the organization.

The third payment means 6 for paying at least a part of both or either of the remittance sum and/or the prize sum is connected to the network 1 so as to reduce the financial burden of the member.

The display device provided with the remittance source information transmission means 2 displays the information provided by the fund provider, and is therefore usable by the fund provider for a publicity campaign or the like.

In addition, the bill collection system, the method for collecting bills and the recording medium wherein the program for making a computer execute the method for collecting bills is recorded is not limited to the above-described embodiments, but also used appropriately by a non-profitable organization such as a volunteer group to collect contributions.

When, for example, the request for participation in prize drawing is received at the remittance source information receiving means 3a, a part of the remittance sum may also be used as at least a part of the prize sum.

The program for making a computer execute the above-described procedures can be created using any object-oriented programming language, for example, the “C” language. Any known encryption software can be used for transmission and receiving among the remittance source information transmission means 2, the bill collection server 3, the first payment means 4, the second payment means 5, the third payment means 6 and the computer means 7 connected to the network 1, and the safeness and the reliability of information security may further be improved.

The present invention will be described with reference to the example.

### EXAMPLE 1

An example of using the bill collection system described in the above embodiment under the following conditions for an organization to collect membership fees will be described.

The prediction information is composed of integers of 0 to 9 and indicated by lower one digit constituting the remittance sum.

Prize winning is judged when the predetermined lower one digit of the fluctuated financial information is identical to the prediction information as a result of collation. The prize sum A to be remitted to a winner is calculated from the following equation:

A=B×X/C (X=50%)

(wherein X represents a predetermined arbitrary rate, B the total remittance sum from the member who has participated in prize drawing and C the number of winners).

The sum D to be remitted to the organization is calculated from the following equation:

D=B−A+E

(wherein E represents the remittance sum from the member who does not participate in prize drawing).

The case wherein 10 members remit a membership fee of 100 to 109 yen, respectively, all members participate in prize drawing, the total remittance sum B is 1,050 yen and the number of winners C is 3 under the above-described conditions, is assumed.

In this case, the prize sum A, which is 1,050×50%=175 yen, is remitted using the second payment means 5 from the bill collection dealer to each member. The sum D to be remitted to the organization, which is 1,050×50%, is remitted using the second payment means 5 from the bill collection dealer to the organization.

### Effect of the Invention

As so-far described, the bill collection system, the method for collecting bills and the recording medium wherein the program for making a computer execute the method for collecting bills is recorded are capable of improving the efficiency of collecting bills.

What I claim is:

1. A bill collection system for collecting bills via a network comprising a bill collection server connected to said network to transmit a first payment request requesting for remittance of said remittance sum and a second payment request requesting for remittance of said remittance sum, said bill collection server comprising:
a remittance source information receiving means for receiving remittance source information including at least a remittance source name, a remittance destination name, a remittance sum, a remittance request and whether or not there is a request for participation in prize drawing;
a storage means for storing said remittance source information;
a prize drawing means for judging whether or not said remittance source wins a prize at a time of receiving said request for participation in prize drawing; and
a prize sum determination means for determining a sum of said prize to be sent to said remittance source when said remittance source wins said prize.

2. A bill collection system according to claim 1, said bill collecting server containing:
a list of participants in prize drawing wherein only remittance source information including information about instruction to a request for participation in prize drawing is extracted and registered from said stored remittance source information; and
a list of receptions of said remittance source information received before a preset time.

3. A bill collection system according to claim 2, wherein said remittance source information includes prediction information predicting fluctuated financial information having a value determined at a preset time in each predetermined period is disclosed;
said bill collection server obtains said preset time and a time of receiving said remittance source information; and
said prize drawing means judges whether said remittance source wins a prize from a value of said fluctuated financial information related to said preset time by using said list of receptions before a preset time.

4. A bill collection system according to claim 3, wherein said remittance source information receiving means generates said prediction information from received said remittance sum.

5. A bill collection system according to claim 3, wherein said bill collection server comprises a prediction information disclosure means for disclosing said prediction information stored in said bill collection server.

6. A bill collection system according to any one of claims 1, wherein said remittance source information receiving means receives information indicating whether or not to transmit said remittance source information to said remittance destination.

7. A bill collection system according to any one of claims 1, wherein a payment means for paying at least a part of both or either of said remittance sum and/or said prize sum and a display device for displaying contents received at said remittance source information receiving means are connected to said network; and
said display device displays information provided by a fund provider who provides funds to said payment means is displayed when displaying said contents of received information.

8. A bill collection system according to claim 1, said system is used by an organization constituted by a plurality of members to collect membership fees from said members.

9. A bill collecting system according to claim 1, wherein said remittance sum is a contribution sum.

10. A bill collection means for collecting bills via a network comprising the steps of:
providing remittance source information receiving means provided with said bill collection server connected via said network receiving said remittance source information including at least a remittance source name, a remittance destination name, a remittance sum, a remittance request and whether there is a request for participation in prize drawing;
storing said storage means provided with said bill collection server said remittance information;
wherein when said bill collection server receives said request for participation in prize drawing, prize drawing means provided with said bill collection server judges whether or not said remittance source wins a prize, when said remittance source wins a prize, said prize sum determination means provided with said bill collection server determines a prize sum to be remitted to said remittance source; said bill collection server transmits said first payment request requesting for remittance of said remittance sum; and said bill collection server transmits said second payment request requesting for remittance of said remittance sum.

11. A recording medium wherein a program readable by a computer for making a computer execute said bill collection means for collecting bills via said network is recorded, said program makes said bill collection server connected via said network execute steps of:
providing said remittance source information receiving means provided with said bill collection server receiving said remittance source information including at least a remittance source name, a remittance destination name, a remittance sum, a remittance request and whether there is a request for participation in prize drawing;
storing said storage means provided with said bill collection server storing said remittance source information;
wherein when said bill collection server receives said request for participation in prize drawing, said prize drawing means provided with said bill collection server judges whether or not said remittance source wins a prize;
when said remittance source wins a prize, said prize sum determination means provided with said bill collection server determines said prize sum to be remitted to said remittance source; said bill collection server transmits said first payment request requesting for remittance of said remittance sum; and said bill collection server transmits said second payment request requesting for remittance of said prize sum.
